(19) United States
(12) Patent Application Publication
(10) Pub. No.: US 2018/0177140 A1
(43) Pub. Date: Jun. 28, 2018

(54) CONTROLLED ENVIRONMENT GREENHOUSE

(71) Applicant: James Gallant, Amherstburg (CA)

(72) Inventor: James Gallant, Amherstburg (CA)

(21) Appl. No.: 15/388,352

(22) Filed: Dec. 22, 2016

(51) Int. Cl. A01G 9/24; E04D 13/17; E04D 3/06; E04B 1/32; A01G 9/14; A01G 9/26; E04H 5/08; E04H 15/20

(52) U.S. Cl. CPC A01G 9/24; E04D 13/17; E04D 3/06; E04B 1/32; E04H 2015/205; A01G 9/26; E04H 5/08; E04H 15/20; E04H 2015/203; A01G 9/1407

(57) ABSTRACT

An exemplary controlled environment greenhouse may include an inner membrane defining an interior space and having at least one opening. The greenhouse may also include an outer membrane arranged outside of the inner membrane to define an air gap therebetween. The greenhouse may further include at least one fan configured to draw air from within the interior space through the at least one opening into the air gap, and recirculate the drawn air back into the interior space. The greenhouse may further include at least one heat exchanger configured to enable heat transfer between the drawn air and a heat transfer medium. The greenhouse may have a dome-shaped or arcuate cross-section.

### BACKGROUND

Greenhouses are traditionally referred to as “hot houses” because they capture solar energy, making them hotter and more humid than outside. To account for this effect, greenhouses can be cooled and dehumidified using a combination of shade curtains and evaporative and mechanical cooling. However, because such greenhouses are typically designed to introduce as much natural sunlight as possible, they generally are poorly insulated, and therefore require a lot of supplemental heating during cold weather. During warm weather, temperatures and humidity may rise to levels that hinder growth of the plants. As such, it may not be economically viable or feasible to implement greenhouses in geographic locations that have seasonal weather extremes, or the amount of time in which to operate a greenhouse is reduced.

In addition, traditional greenhouses use CO₂ enrichment to promote photosynthesis during periods when sunlight is not a constraint. The cheapest source of CO₂ is natural gas combustion exhaust when and where natural gas is available. So, during sunlight hours, typical greenhouses burn natural gas, condense the vapors out of the exhaust and distribute the CO₂ rich exhaust throughout the greenhouse via polyethylene ducts and tubes. The energy produced through day time natural gas combustion is typically not required at the time, when CO₂ is required, and therefore may be stored for future use, usually in the form of hot water. When and where natural gas is not available, liquid CO₂ is employed but it costs several times more than CO₂ from natural gas.

Accordingly, there is a need for an improved controlled environment greenhouse that can be effectively operated year-round in areas having extreme temperature and climates.

### BRIEF DESCRIPTION OF THE DRAWINGS

While the claims are not limited to the illustrated examples, an appreciation of various aspects is best gained through a discussion of various examples thereof. Referring now to the drawings, exemplary illustrations are shown in detail. Although the drawings represent representative examples, the drawings are not necessarily to scale and certain features may be exaggerated to better illustrate and explain an innovative aspect of an illustrative example. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1 is a schematic flow diagram of an exemplary controlled environment greenhouse;

FIG. 2 is a cross-sectional perspective view of an exemplary controlled environment greenhouse;

FIG. 3 is cross-sectional front view illustrating an elevation of the greenhouse of FIG. 2;

FIG. 4 is cross-sectional side view of the greenhouse of FIG. 2;

FIG. 5 is a cross-sectional top view illustrating a foundation of the greenhouse of FIG. 2; and

FIG. 6 is a flow diagram of an exemplary process for controlling the environment of a greenhouse.

### DETAILED DESCRIPTION

Reference in the specification to “one embodiment,” “an embodiment,” “an example,” or the like, means that a particular feature, structure, or characteristic described in connection with the embodiment is included in at least one exemplary illustration. The appearances of the phrase “in one example,” etc. in various places in the specification are not necessarily all referring to the same exemplary illustration.

Various exemplary illustrations are provided herein of greenhouses and processes for controlling the environment of such greenhouses. An exemplary greenhouse may include an inner membrane defining an interior space and having at least one opening. The greenhouse may also include an outer membrane arranged outside of the inner membrane such that an air gap is defined between the inner membrane and the outer membrane. The greenhouse may further include at least one fan configured to draw air from within the interior space through the at least one opening in the inner membrane and into the air gap, and to recirculate the drawn air back into the interior space from beneath the interior space.

An exemplary process for controlling the environment of a greenhouse may include drawing air from an interior space of the greenhouse through at least one opening in an inner membrane of the greenhouse defining the interior space. The air may be drawn into an air gap between the inner membrane and an outer membrane arranged outside of the inner membrane. The process may further include recirculating the air through the air gap back into the interior space from beneath the interior space.

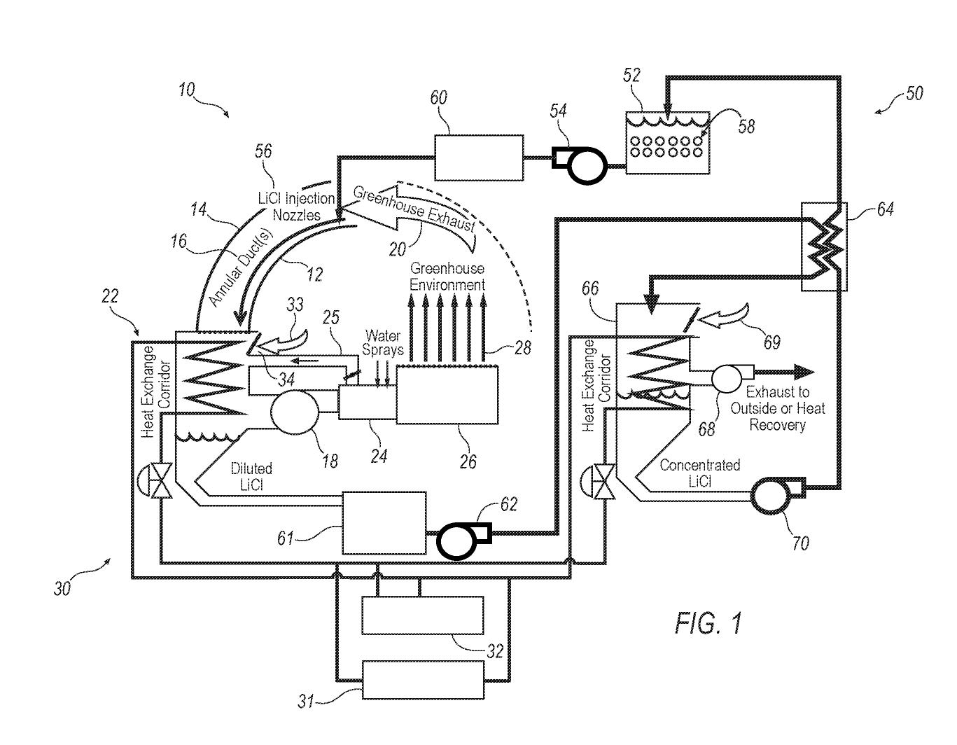

Turning now to the figures, FIG. 1 illustrates an exemplary flow diagram of a controlled environment greenhouse 10. The greenhouse 10 may include an inner membrane 12 and an outer membrane 14 defining an air flow passageway or duct 16 therebetween. The greenhouse 10 may also include a fan 18 configured to draw greenhouse exhaust, represented by arrow 20, from an interior space of the greenhouse 10 into the duct 16. The fan 18 may be a modulating, forced draft fan. The greenhouse exhaust may flow through the duct 16 and subsequently through heat exchangers 22 and 24, which may enable heating, cooling, and/or dehumidification of the greenhouse exhaust. Finally, the greenhouse exhaust may flow through a supply or distribution plenum 26, which may distribute the greenhouse exhaust back into the interior space of the greenhouse 10, as represented by arrows 28.

The greenhouse 10 may also include a heat transfer circuit 30 configured to circulate a heat transfer medium to at least one of heat exchangers 22 and 24. The heat transfer circuit 30 may include at least one heat transfer medium storage 31 and at least one heating and/or cooling source 32 configured to heat or cool the heat transfer medium, including, but not limited to a boiler, a cooling tower, or a vapor compression cooler. As merely one example, the heat transfer medium may be hot water heated by the heating and/or cooling source 32, in the form of a boiler, and supplied to the heat exchanger 22 to provide sensible heating of the greenhouse exhaust. The heat transfer circuit 30 may include any number of flow control devices, including, but not limited to valves, pumps, flow meters, and the like to enable and control the circulation of the heat transfer medium through the heat exchanger(s) 22, 24. In addition, the heat transfer medium storage 31 and the heating/cooling source 32 may be in a single unit.

Heat exchanger 22 may be configured to introduce make-up or outside air 33, for example, via an air intake damper or louver 34, which may or may not be motorized and/or automatically operated. To provide evaporative cooling of the greenhouse exhaust, the heat exchanger 24 may enable heat transfer from a cooling medium to the greenhouse exhaust. As merely one example, cold water may be sprayed in the heat exchanger 24 as the greenhouse exhaust is flowing through, as illustrated in FIG. 1, to provide evaporative cooling. The use of evaporative cooling can prove very beneficial during warm weather operation by preserving acceptable temperatures/humidity within the greenhouse 10. However, any known cooling source may be utilized in addition to in lieu of such evaporative cooling of the greenhouse exhaust. Greenhouse 10 may also include a bypass 25 to allow a portion of the conditioned and/or treated greenhouse exhaust to bypass the interior of greenhouse 10 back into heat exchanger 22 to control the amount of greenhouse exhaust and temperature of the greenhouse exhaust flowing through the interior greenhouse 10 while allowing a larger air flow for conditioning by heat exchanger 22. Bypass 25 may include an adjustable damper to control and adjust the amount of bypass greenhouse exhaust. While FIG. 1 illustrates the heat exchangers 22 and 24 as separate heat exchangers, it should be appreciated that they may be combined in a single heat exchanger. In addition, while FIG. 1 illustrates the fan 18 to be downstream of heat exchanger 22 and upstream of heat exchanger 24, it should be appreciated that the fan 14 may be in any location, including upstream of the heat exchanger 22 adjacent the duct 16 or downstream of the heat exchanger 24. Further, greenhouse 10 may include more than one fan 14.

The greenhouse 10 may further include an air treatment system 50 configured to treat the greenhouse exhaust flowing through the duct 16, for example, dehumidification and/or temperature control of the greenhouse exhaust. While the air treatment system 50 is described hereinafter as utilizing a liquid desiccant, it should be appreciated that any known substance may be utilized to treat the air. In one exemplary approach, concentrated liquid desiccant may be supplied via a pump 54 to a plurality of injection nozzles 56 from a concentrated liquid desiccant storage 52. The liquid desiccant may be any known liquid desiccant, including, but not limited to, lithium chloride, potassium formate, calcium chloride, and the like. The concentrated liquid desiccant storage 52 may include cooling tubes 58 through which cooling fluid may flow to cool and maintain the concentrated liquid desiccant at a desired temperature. The air treatment system 50 may also include a supplemental cooler 60 to provide further cooling of the concentrated liquid desiccant being supplied to the injection nozzles 56. While FIG. 1 illustrates the supplemental cooler 60 downstream of the pump 54, it should be appreciated that the supplemental cooler 60 may alternatively be located upstream of the pump 54. The injection nozzles 56 generally may be configured to dispense the concentrated liquid desiccant in a steady stream on to an outer surface of the inner membrane 12 within the duct 16. Because the liquid desiccant is dispensed in the duct 16 and/or in the heat exchanger 22 and not in the interior space of the greenhouse 10, the liquid desiccant does not come into direct contact with the plants housed and cultivated therein. In addition, the fan 18 and/or the pump 54 may be set at speeds such that the greenhouse exhaust will not carry the liquid desiccant back into the interior space, thereby further preventing direct contact between the plants and the liquid desiccant.

As the greenhouse exhaust passes through the duct 16 and/or the heat exchanger 22 and comes into contact with the concentrated liquid desiccant, moisture and latent heat may be removed from the greenhouse exhaust by the concentrated liquid desiccant, thereby resulting in diluted liquid desiccant. As described in more detail hereinafter, the diluted liquid desiccant may be collected and stored in a diluted liquid desiccant storage 61. The diluted liquid desiccant may be transferred from the storage 61 via a pump 62 through a heat exchanger 64 to exchange heat with the concentrated liquid desiccant, and to a liquid desiccant regenerator 66 to remove the moisture from the diluted liquid desiccant. To achieve this, the regenerator 66 generally may enable heat transfer between a heat transfer medium and the diluted liquid desiccant to remove the moisture therefrom. The heat transfer medium may be, but is not limited to, hot water, for example, from the heat transfer circuit 30. It should be appreciated that the heat transfer medium may be in a separate dedicated circuit than that provided for the heat exchanger 22. A fan 68 may circulate fresh air 69 through the regenerator 66 to take the moisture away. The resultant concentrated liquid desiccant may then be pumped back to the concentrated liquid desiccant storage 52 via a pump 70. It should be appreciated that pumps 54 and 70 may be combined into a single pump, or that the air treatment system 50 may include additional pumps. In addition, the regenerator 66 may be the same device or heat exchange means as the heat exchanger 22. Further, while not illustrated, air treatment system 50 may include any additional flow control devices, including, but not limited to, valves, flow meters, and the like to enable and control the circulation of the liquid desiccant.

The operation of any of the devices of the greenhouse 10, including, but not limited to, the fan 18, the flow of the heat transfer medium in the heat transfer circuit 30, the heating/cooling source 32, pumps 54 and 70, and fan 68, generally may be controlled to maintain certain properties of the greenhouse exhaust, including, but not limited to, the temperature and humidity of the greenhouse exhaust. For example, at least one controller (not shown) may be connected to the various devices and adjust their respective operation (e.g., speed) based on the temperature and humidity as measured by sensors (not shown) within the greenhouse. Thus, the overall environment of the greenhouse may be controlled to account for fluctuations in temperature and other different weather conditions, irrespective of the geographical location of the greenhouse 10.

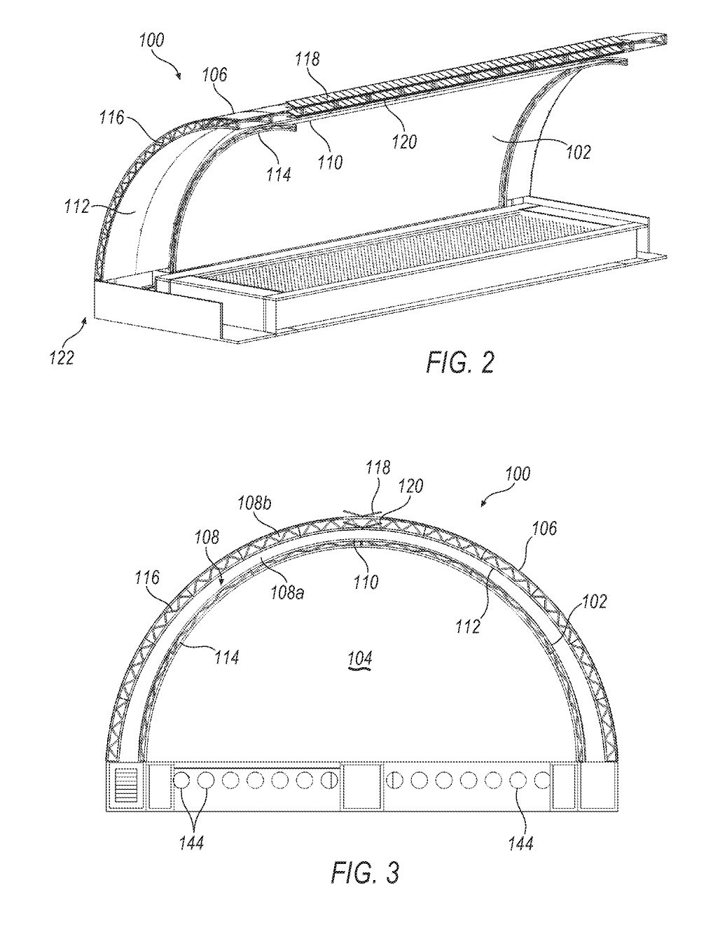

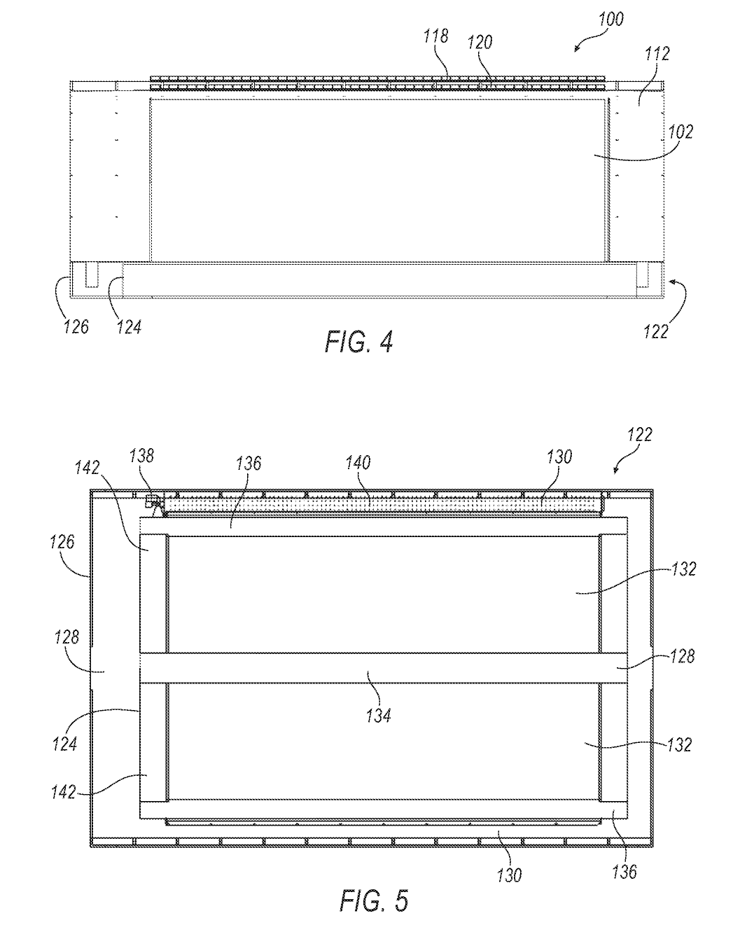

Referring now to FIGS. 2-5, an exemplary controlled environment greenhouse 100 is illustrated. The greenhouse 100 may be dome shaped and/or have a generally arcuate cross-sectional shape. With such a shape, the greenhouse 100 may have a high center, thereby providing more height than is needed to accommodate a single level of plants, and thereby allows for a greater planting density with multiple levels of plants. The greenhouse 100 may include an inner membrane 102 defining an interior space 104 in which plants are housed and cultivated, and an outer membrane 106 disposed outside of the inner membrane 102 to define an air gap 108 between the inner membrane 102 and the outer membrane 106. The air gap 108 generally may function as an air flow passage or duct through which air drawn from within the interior space 104 may flow and be recirculated, as described in more detail below. The inner membrane 102 may have at least one opening 110 through which the air may be drawn into the air gap 108. The opening 110 may be located at or near the top or crest of the inner membrane 102, and may also run in a longitudinal direction along at least a portion of the length of the greenhouse 100. It should be appreciated that the opening 110 may include multiple openings in the longitudinal direction and/or a lateral or circumferential direction, and that may or may not be the same size. In addition, the size of the opening 110 may be manually or automatically adjusted in order to control the amount of air being drawn into the air gap 108 and/or the pressure within the interior space 104. For example, the greenhouse may include a cover (not shown) that may slide at least partially over the opening 110 via tracks, rollers, linkages, or any other known mechanism, which may be motorized.

The greenhouse 100 may also include inner structural trusses 114 and/or outer structural trusses 116 to provide structural support for the inner membrane 102 and the outer membrane 106, respectively. The outer membrane 106 may be attached to the outside of the outer structural trusses 116, and the inner membrane 102 may be attached to the outside of the inner structural trusses 114. In addition or alternatively, the inner membrane 102 may be at least partially supported by the air pressure of the air within the interior space 104, for example, if the inner membrane 102 is inflatable. In such a scenario, the inner structural trusses 114 may be reduced in size and/or number, or potentially eliminated, thereby reducing or eliminating a shadowing effect of the trusses.

The greenhouse 100 may also include a middle membrane 112 disposed between the inner membrane 102 and dividing the air gap 108 into a first air gap 108a between the inner membrane 102 and the middle membrane 112, and a second air gap 108b between the middle membrane 112 and the outer membrane 106. The first air gap 108a may serve as the air flow passage or duct for the recirculated air, and the second air gap 108b may provide thermal insulation via the air therein and/or any other insulating material within the second air gap 108b.

The greenhouse 100 may include energy curtains that may be selectively drawn up and down between the inner membrane 102 and the middle membrane 112. Such energy curtains may be employed during night time and/or cold weather periods to keep the recirculated air flow away from the cold, inside surface of the middle membrane 112. Alternatively, the recirculated air flowing through the air gap 108a may be allowed to impinge upon the inside surface of the middle membrane 112 to promote dehumidification through condensation. In order to promote or regulate the rate of condensation, the outer membrane vent 118 may be cracked open during cold weather to promote the natural convection of the warmer air between the outer membrane 106 and the middle membrane 112. The condensation may then flow within the air gap 108a down the inner surface of the middle membrane 112 and/or the outer surface of the inner membrane 102 where it may be collected to be used or otherwise discarded. As such, the condensation will not drip or form on the plants, thereby keeping the plants dry and protected against mildew and disease.

At least part of the inner membrane 102, the outer membrane 106, and/or the middle membrane 112 may be made of a material that is at least semi-transparent to allow sunlight into the interior space 104 to reach the plants being cultivated therein. For example, the material may be, but is not limited to, greenhouse polyethylene or ethylene tetrafluoroethylene. The respective materials of the inner membrane 102, the outer membrane 106, and the middle membrane 112 may or may not be the same, and the transmissivity of the respective materials may differ. Because the sunlight travels through multiple membranes, the greenhouse may need to incorporate more artificial lighting, i.e., grow lights (not shown). The use of such artificial lighting may allow for a greater planting density, depending upon the location and orientation of such artificial lighting and plants, as well as enable the greenhouse 100 to be operated during seasons or geographical locations in which sunlight is reduced. In addition, any heat generated by the artificial lighting may be absorbed into the recirculated air and redistributed throughout the greenhouse, as explained above with respect to FIG. 1. In contrast traditional greenhouses implementing such artificial lighting vent a large proportion of the heat because they cannot efficiently draw heat from the lights, which are generally positioned in overhead locations.

The outer membrane 106 and/or the middle membrane 112 may be selectively removable or retractable, for example, in warmer weather periods when thermal insulation may not be necessary, which may increase the amount of sunlight available to the plants. The membranes 106 and 112 may be manually or automatically removed or retracted. For example, the outer structural trusses 116 may have tracks, which may be motorized, or slots on an interior side and/or an exterior side on or in which the outer membrane 106 and the middle membrane 112, respectively, may be movably secured.

The outer membrane 106 and/or the middle membrane 112 may also include at least one vent 118, 120 to control the pressure of the air in any of the air gaps 108, 108a, and 108b. The vents 118, 120 may be located at or near the top or crest of the respective membrane, and may run in the longitudinal direction along at least a portion of the length of the greenhouse. While the figures illustrate one vent 118, 120 for each of the respective membranes 106, 112, it should be appreciated that each membrane 106, 112 may have any number of vents in the longitudinal direction and/or a lateral or circumferential direction and that may or may not be the same size. In addition, the vents 118, 120 may be manually or automatically adjusted. For example, the vents 118, 120 may include dampers, flaps or covers that that may be slid, rotated, or otherwise moved via tracks, rollers, linkages, or any other known mechanism, which may be motorized.

The greenhouse 100 may also have a foundation 122, which may include an inner foundation wall 124 and an outer foundation wall 126. The inner foundation wall 124 generally may support the inner structural trusses 114, and the outer foundation wall 126 may support the outer structural trusses 116. Between the inner foundation wall 124 and the outer foundation wall 126, the foundation 122 may include lateral or end corridors 128 and longitudinal or side corridors 130. The inner foundation wall 124 may also define a space 132 generally located beneath the interior space 104. The foundation 122 may further include a center plenum or aisle 134 and side plenums or aisles 136 passing through the space 132 in the longitudinal direction. The top of at least one of the aisles 134, 136 may be used as a walkway in the interior space 104 to access the plants therein. In addition, the aisles 134, 136 may be used as covered, insulated storage for hot water or liquid desiccant, as described below.

The greenhouse 100 generally may include at least one fan 138 located in the foundation 122 such that air may be drawn from the top of the air gap 108 down to the foundation 122. While FIG. 5 illustrates one fan 138 located at an end of one of the corridors 130, it should be appreciated that the greenhouse 100 may include any number of fans 138 at different locations to provide equal air flow through the air gap 108 laterally/radially and longitudinally, and depending on the amount of air to be recirculated. At least one of the side corridors 130 may be configured as a heat exchange corridor 140, which generally may be a plenum in which the air properties may be controlled. For example, a heat transfer medium (not shown) may be circulated in the heat exchange corridor 140 such that when the air exits the air gap 108 into the heat exchange corridor 140, the heat transfer medium may exchange heat with the air as it flows down the corridor 140 to the fan 138. The outer foundation wall 126 and/or the heat exchange corridor 140 may include a louver or the like to introduce outside or make-up air into the heat exchange corridor 140 as needed. In addition, the heat exchange corridor 140 may include another louver or the like to allow a portion of recirculated air to enter the heat exchange corridor 140. At least one heating/cooling source (not shown) and/or at least one heat transfer medium storage (not shown) for heating/cooling and storing the heat transfer medium may be located anywhere in the foundation 122, including one or more of the end corridors 128, side corridors 130, and/or the aisles 134, 136, and/or may be located external to the greenhouse 100.

Downstream of the heat exchange corridor 140, the fan 138 may distribute the air into one or more air distribution plenums 142, which may subsequently distribute the air into the space 132 and up into the interior space 104. To achieve this, the greenhouse 100 may include a plurality of ducts 144 running longitudinally through the space 132. The ducts 144 may have vents (not shown) longitudinally spaced and generally oriented upwards toward the interior space 104 such that the air may be distributed therein. Alternatively, at least a portion of the space 132 may function as a plenum for the air. Grates or other permeable panels may be used to cover the space 132 to serve as a floor for the interior space while still allowing the air to flow up into the interior space 104.

By locating the equipment in the foundation 122 and recirculating the air back into the interior space 104 from beneath, the interior space 104 may be maximized and optimized. Thus, the planting density may be increased from traditional greenhouses, and the configuration of the plants may be more customizable to suit the specific type of plants or application for which the greenhouse 100 is being used. Ambient environmental CO₂ concentrations are approximately 300-400 ppm whereas CO₂ levels within a greenhouse need to be maintained at or above 600 ppm whenever photosynthesis is taking place, i.e., when light is being applied. The increased planting density within a modern greenhouse results in CO₂ depleted “micro-climates” within close proximity of the plants' leaf surfaces that can only be alleviated through CO₂ enhancement and good air circulation over every square meter of the greenhouse. However, with the air being recirculated from beneath the plants, CO₂ can be more easily and effectively distributed to the plants, thereby better alleviating the micro-climates. In addition, recirculation of the greenhouse air allows complete recovery and recirculation of all CO₂ injected into the greenhouse but not assimilated through photosynthesis, greatly minimizing the loss of CO₂ through the venting, and thereby reducing the need for additional CO₂ sources, such as natural gas or liquid CO₂. Further, having the air recirculate from within the interior space 104 through the air gap 108, 108a creates a “cocoon” around the interior space 104, and allows for more even circulation and distribution of air from and to the interior space 104, thereby allowing for better control of the greenhouse environment relating to at least temperature and humidity.

While greenhouse 100 is described as having the air flow through the opening 110 in the inner membrane 102 down through the air gap 108, 108a and back into the interior space 104 from beneath, it should be appreciated that greenhouse 100 may be configured to, in addition or alternatively, have the air drawn down into the foundation 122, up through the air gap 108, 108a, and back into the interior space 104 from above, for example, through the opening 110. The fan 138 may be reversible to alternate the direction of flow. In addition, the inner membrane 102 may include multiple openings 110 along the inner membrane 102 in a circumferential direction so as to allow air to recirculate back into the interior space 104 at varying elevations.

While not illustrated in FIGS. 2-5, the greenhouse 100 may also include an air treatment system, such as the air treatment system 50 illustrated in FIG. 1, configured to provide dehumidification and/or temperature control of the recirculated air, for example, through the use of a liquid desiccant. The air treatment system may include piping through which the liquid desiccant may flow and be supplied to a plurality of nozzles configured to dispense the liquid desiccant in a continuous stream onto the outer surface of the inner membrane 102 and/or in the heat exchange corridor 140. The piping and nozzles may be located anywhere within the greenhouse 100, including the air gap 108, 108a. For example, the piping may run along at least a portion of one or both edges of the opening 110 of the inner membrane 102. As such, once the air from the interior space 104 is drawn into the air gap 108, 108a, the air will come into contact with the liquid desiccant, thereby maximizing the potential dehumidification of the air. The nozzles may be spaced at even intervals along the length of the piping. The spacing generally should be such to allow the liquid desiccant flow to cover as much surface area of the outer surface of the inner membrane 102 as possible. For example, the nozzles may be spaced at intervals of approximately six inches. To further assist in maximizing the coverage of the liquid desiccant over the outer surface of the inner membrane 102, the greenhouse 100 may include one or more wicking cloths applied to the outer surface. The wicking cloth may be permanently attached to the outer surface or incorporated into the inner membrane 102. Alternatively, the wicking cloth may be removable from the outer surface. For example, the wicking cloth may be able to be raised from and lowered onto the inner membrane 102 to and from the outer structural trusses 116 or the middle membrane 112. The wicking cloth(s) may be sized to cover the entire surface area of the inner membrane 102 or just portion(s) thereof.

At or near the base of the inner membrane 102, the air treatment system may include a collection means for collecting diluted liquid desiccant. As merely one example, the collection means may include one or more open channels or troughs, which may or may not be in or otherwise integrated with the heat exchange corridor(s) 140. The channel(s) may be sloped from one end of the greenhouse 100 to the other to utilize gravity flow of the collected liquid desiccant toward a collection end of the channel and/or to a diluted liquid desiccant storage (not shown). Alternatively, the channel(s) may be sloped from the middle of the greenhouse to both ends, or from both ends to the middle of the greenhouse 100. The air treatment system may also include a liquid desiccant regenerator (not shown) configured to separate water from the collected, diluted liquid desiccant, and at least one pump configured to pump the collected liquid desiccant from the collection end(s) of the channel(s) and/or the diluted liquid desiccant storage tank to the liquid desiccant regenerator, from the liquid desiccant regenerator to a concentrated liquid desiccant storage, and/or from the concentrated liquid desiccant storage to the nozzles. The liquid desiccant regenerator, pump(s), and storage(s) may be located anywhere within the greenhouse 100, including, but not limited to, the end corridor(s) 128, side corridor(s) 130, heat exchange corridor(s) 140, and/or the plenum(s) 134, 136. In addition or alternatively, the liquid desiccant regenerator may utilize the heat transfer medium and/or make-up air circulating or passing through the heat exchange corridor 140.

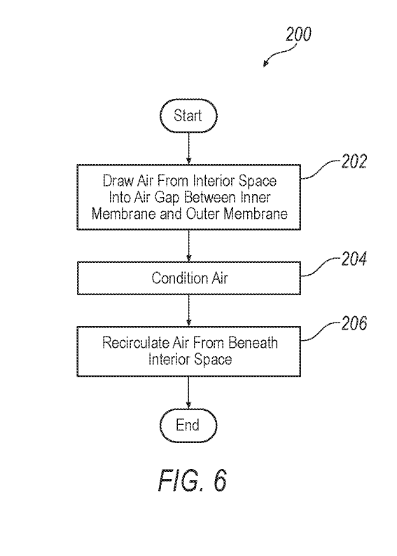

Referring now to FIG. 6, an exemplary process 200 for controlling the environment within a greenhouse is illustrated. While process 200 is described with respect to greenhouse 100, it should be appreciated that process 200 may be applied using any greenhouse having components that may perform the steps of process 200. Process 200 may begin at block 202 in which air within an interior space 104 of the greenhouse 100 may be evenly drawn by at least one fan 138 through at least one opening 110 in an inner membrane 102 of the greenhouse 100 into an air gap 108, 108a between the inner membrane 102 and an outer membrane 106. The air may then flow from the top of the air gap 104 down to a foundation 122 of the greenhouse 100.

Process 200 may then proceed to block 204 at which the drawn air may be conditioned by exchanging heat with a heat transfer medium. For example, the drawn air may flow from the air gap 108, 108a to at least one heat exchange corridor 140 in which the heat transfer medium, in the form of a heating medium, is circulated, to provide sensible heat for the drawn air. In addition or alternative, the heat transfer medium may be a cooling medium, such as cold water spray. The amount of conditioning may be determined based on at least one of a humidity and a temperature of the air within the interior space 104. Conditioning the air may also include treating the drawn air in the air gap 108, 108a. For example, a liquid desiccant may be dispensed on an outer surface of the inner membrane 102 such that at least a portion of the drawn air flowing through the air gap 108, 108a comes into contact with the liquid desiccant.

Process 200 may then proceed to block 206 in which the drawn air may be evenly recirculated into the interior space 104. For example, the fan 138 may distribute the air into at least one air distribution plenum 142 from which the air may then flow into a plenum and/or a plurality of ducts 144 located beneath the interior space 104. From the plenum and/or ducts 144, the drawn air may flow back into the interior space 104. Process 200 may continually repeat as long as the greenhouse 100 is operational, automatically adjusting for changes in such factors as outside temperature.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A greenhouse comprising:
an inner membrane defining an interior space, the inner membrane having at least one opening;
an outer membrane arranged outside of the inner membrane, an air gap being defined between the inner membrane and the outer membrane;
at least one fan configured to draw air from within the interior space through the at least one opening into the air gap, and recirculate the drawn air back into the interior space; and
at least one heat exchanger configured to enable heat transfer between the drawn air and a heat transfer medium.

2. The greenhouse of claim 1, wherein the at least one heat exchanger includes at least one heat exchange corridor through which the drawn air flows from the air gap to a supply air plenum via which the drawn air is distributed back into the interior space, the heat transfer medium flowing through the at least one heat exchange corridor.

3. The greenhouse of claim 1, wherein at least one of the inner membrane and the outer membrane is at least partially made of a material that is at least semi-transparent.

4. The greenhouse of claim 3, wherein the material is one of polyethylene and ethylene tetrafluoroethylene.

5. The greenhouse of claim 1, further comprising a middle membrane disposed between the inner membrane and the outer membrane and splitting the air gap into a first air gap between the inner membrane and the middle membrane, and a second air gap between the middle membrane and the outer membrane, the drawn air being flowable through the first air gap.

6. The greenhouse of claim 1, further comprising at least one of outer structural trusses to which the outer membrane is attached, and inner structural trusses to which the inner membrane is attached.

7. The greenhouse of claim 1, wherein a size of the at least one opening in the inner membrane is adjustable.

8. The greenhouse of claim 1, wherein the outer membrane includes at least one vent.

9. The greenhouse of claim 1, further comprising an air treatment system configured to treat the drawn air flowing in the air gap.

10. The greenhouse of claim 9, wherein the air treatment system includes a plurality of nozzles configured to dispense a liquid desiccant at least one of on an outer surface of the inner membrane and in the at least one heat exchanger.

11. The greenhouse of claim 1, wherein the greenhouse has at least one of a dome shape and an arcuate cross-section.

12. The greenhouse of claim 1, wherein the inner membrane is at least partially supported by air pressure of the air within the interior space.

13. A process comprising:
drawing air from an interior space of a greenhouse through at least one opening in an inner membrane of the greenhouse defining the interior space into an air gap between the inner membrane and an outer membrane;
transferring heat between the drawn air and a heat transfer medium based on at least one of a humidity and a temperature of the air within the interior space; and
recirculating the air through the air gap back into the interior space from beneath the interior space.

14. The process of claim 13, wherein transferring heat between the drawn air and the heat transfer medium includes circulating the heat transfer medium in a heat exchange corridor between the air gap and a supply air plenum via which the air is distributed back into the interior space.

15. The process of claim 13, further comprising treating the drawn air in the air gap.

16. The process of claim 15, wherein treating the drawn air includes dispensing a liquid desiccant at least one of on an outer surface of the inner membrane and in the heat exchanger such that at least a portion of the drawn air flowing through the air gap comes into contact with the liquid desiccant.

17. A greenhouse comprising:
an inner membrane defining an interior space, the inner membrane having at least one opening;
an outer membrane arranged outside of the inner membrane, an air gap being defined between the inner membrane and the outer membrane;
a middle membrane disposed between the inner membrane and the outer membrane and splitting the air gap into a first air gap between the inner membrane and the middle membrane, and a second air gap between the middle membrane and the outer membrane; and
at least one fan configured to draw air from within the interior space through the at least one opening into the first air gap, and recirculate the drawn air back into the interior space from beneath the interior space;
at least one heat exchanger configured to enable heat transfer between the drawn air and a heat transfer medium;
wherein at least one of the inner membrane, the middle membrane, and the outer membrane is at least partially made of a material that is at least semi-transparent.

18. The greenhouse of claim 17, wherein the greenhouse has at least one of a dome shape and an arcuate cross-section.

19. The greenhouse of claim 17, wherein the inner membrane is at least partially supported by air pressure of the air within the interior space.

20. The greenhouse of claim 17, wherein the at least one heat exchanger includes at least one heat exchange corridor through which the drawn air flows from the air gap to a supply air plenum via which the drawn air is distributed back into the interior space, the heat transfer medium flowing through the at least one heat exchange corridor.
